(19) United States
(12) Patent Application Publication
(10) Pub. No.: US 2005/0262873 A1
(43) Pub. Date: Dec. 1, 2005

(54) Refrigeration cycle

(75) Inventor: Hisatoshi Hirota, Tokyo (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: TGK CO. LTD., Tokyo (JP)

(21) Appl. No.: 11/135,466

(22) Filed: May 24, 2005

(30) Foreign Application Priority Data
May 27, 2004 (JP) 2004-157260

(51) Int. Cl. G01K 13/00; F25B 41/00; F25B 43/00

(52) U.S. Cl. 62/503; 62/513

(57) ABSTRACT

To provide a refrigeration cycle capable of improving the coefficient of performance without lowering the cooling power thereof. According to a refrigeration cycle of the present invention, it is possible to adjust the flow rate of liquid refrigerant to be mixed with gaseous refrigerant in a U-shaped pipe by a control valve integrally formed with an accumulator, and enhance the degree of dryness of refrigerant delivered from the accumulator while securing the required amount of lubricating oil. As a result, it is possible to increase the degree of superheat of refrigerant introduced into a compressor, thereby making it possible to improve the coefficient of performance of the refrigeration cycle. In doing this, there is no need to lower the pressure of refrigerant discharged from the compressor, and hence the improvement in the coefficient of performance can be realized without lowering the cooling power of the refrigeration cycle.

### CROSS-REFERENCES TO RELATED APPLICATIONS, IF ANY

This application claims priority of Japanese Application No. 2004-157260 filed on May 27, 2004 and entitled “REFRIGERATION CYCLE”.

### BACKGROUND OF THE INVENTION

(1) Field of the Invention

The present invention relates to a refrigeration cycle and more particularly to a refrigeration cycle in which refrigerant pressure on a high pressure side is not lower than the critical pressure of refrigerant (hereinafter referred to as “supercritical refrigeration cycle”).

(2) Description of the Related Art

Conventionally, chlorofluorocarbons have been used as refrigerant for refrigeration cycles of automotive air conditions. However, due to the problem of ozone layer destruction, recently, a refrigeration cycle using e.g. carbon dioxide (CO₂) as refrigerant instead of chlorofluorocarbons is under development (see Japanese Unexamined Patent Publication (Kokai) No. 2001-201213 (Paragraph numbers [0002], [0018]-[0027], and so forth)). In the refrigeration cycle using e.g. carbon dioxide, the refrigerant pressure on the high pressure side is not lower than the critical pressure of refrigerant, and hence this cycle is called “supercritical refrigerant cycle”.

FIG. 4 is a diagram showing a system configuration of such a conventional supercritical refrigeration cycle as described above.

This supercritical refrigeration cycle comprises a compressor 101 for increasing the pressure of refrigerant to a supercritical region, a gas cooler 102 for cooling the pressurized refrigerant, an expansion device 103 for decompressing refrigerant sent from the gas cooler 102, an evaporator 104 for evaporating the decompressed refrigerant, an accumulator 105 (lower pressure liquid reservoir) for storing surplus refrigerant, and an internal heat exchanger 106 for further cooling the refrigerant cooled by the gas cooler 102 by refrigerant sent from the accumulator 105 to the compressor 101.

Here, the accumulator 105 separates the refrigerant flowing out from the evaporator 104 into gaseous refrigerant and liquid refrigerant, and sends out mainly the gaseous refrigerant to the compressor side. The liquid refrigerant stored in the accumulator 101, however, contains lubricating oil for the compressor 101, which has been discharged from the compressor 101 together with high-pressure refrigerant and circulated through the supercritical refrigeration cycle. More specifically, the lubricating oil dissolves in the liquid refrigerant, and hence assuming that only the gaseous refrigerant is returned to the compressor 101 from the accumulator 105, the lubricating oil for the compressor 101 becomes short, which can cause seizure of the compressor 101, resulting in breakage of the same. To prevent this problem, for example, the accumulator 105 is formed with a small hole for causing the liquid refrigerant to flow out therethrough at a low flow rate.

With the above-described configuration, the refrigerant flowing out from the outlet of the compressor 101 is cooled by the gas cooler 102, then passes through the internal heat exchanger 106, and is decompressed by the expansion device 103, followed by being introduced into the evaporator 104. Refrigerant having being evaporated by passage through the evaporator 104 is introduced into the accumulator 105. At this time, not all of the refrigerant introduced into the evaporator 104 evaporate, and hence the refrigerant having passed through the evaporator 104 is once separated into the liquid refrigerant and the gaseous refrigerant. In the accumulator 105, which sends mainly the gaseous refrigerant to the compressor side via the outlet side piping connected thereto, the aforementioned small hole is formed through a bottom portion of the aforementioned refrigerant piping, and the ratio of the size of the small hole to the size of passage cross-section of the refrigerant passage determines the outflow rate of the liquid refrigerant. The refrigerant sent from the accumulator 105 exchanges heat with the refrigerant sent from the gas cooler 102, followed by being introduced into the compressor 101.

In the supercritical refrigeration cycle described above, the ratio of the size of the small hole to the size of passage cross-section of the refrigerant piping of the accumulator 105 determines the dryness of the refrigerant sent from the accumulator 105, and as the small hole is larger in size, the proportion of the liquid refrigerant increases. Normally, the internal heat exchanger 106 performs heat exchange, so that the refrigerant at the inlet of the compressor 101 is in an superheated vapor status.

Incidentally, as is distinct from the refrigeration cycle using a chlorofluorocarbon, in the supercritical refrigeration cycle using carbon dioxide, the refrigerant is not condensed on the high pressure side, so that to cool the refrigerant efficiently by the gas cooler 102, it is preferable to increase the temperature difference between the refrigerant and the air or the like for cooling the refrigerant. In short, it is preferable that the temperature of the refrigerant flowing into the gas cooler 102 is made as high as possible. As for this, the temperature at the outlet of the compressor 101 can be raised by increasing the degree of superheat of the refrigerant at the inlet of the compressor 101.

In this case, if the temperature of the refrigerant becomes too high, there occurs a problem that the lubricating oil for the compressor 101 is degraded due to high temperature. To avoid this problem, conventionally, a control valve for a variable displacement compressor or the like is used to provide control so as to prevent the discharge pressure of the compressor 101 from becoming too high, to thereby prevent the temperature at the outlet of the compressor 101 from becoming too high.

However, if the discharge pressure of the compressor 101 is lowered, the suction force of the compressor 101 is lowered accordingly, which increases the suction pressure. As a result, there occurs another problem that the vaporization temperature of the refrigerant passing through the evaporator 104 becomes higher to reduce the cooling power of the refrigeration cycle. Although this problem is particularly conspicuous in the supercritical refrigeration cycle, it can occur in ordinary refrigeration cycles using the chlorofluorocarbon or the like.

### SUMMARY OF THE INVENTION

The present invention has been made in view of these points and an object thereof is to provide a refrigeration cycle capable of improving the coefficient of performance without lowering the cooling power thereof.

To solve the above problem, the present invention provides a refrigeration cycle comprising a compressor for compressing refrigerant containing lubricating oil, an external heat exchanger for cooling the refrigerant discharged from the compressor, an expansion device for decompressing the refrigerant sent from the external heat exchanger, an evaporator for evaporating the refrigerant decompressed by the expansion device, an accumulator for storing the refrigerant sent from the evaporator while causing gas-liquid separation thereof, and an internal heat exchanger for performing heat exchange between the refrigerant sent from the accumulator to the compressor and the refrigerant sent from the external heat exchanger to the expansion device, wherein the accumulator comprises a tank for storing the refrigerant sent from the compressor, an internal piping having a body accommodated in the tank, the body having one end which opens into a gaseous phase portion within the tank and the other end which extends through the tank so as to be connected to a the internal heat exchanger side, and further the body being formed with a valve hole having a predetermined size, for communication with a liquid phase portion within the tank, and a control valve having a main body formed integrally with the tank, a valve element disposed within the main body such that the valve element can be moved to and away from the valve hole and forming a valve portion for opening and closing the valve hole, and control means for causing the valve element to be driven in a direction of opening or closing the valve portion to thereby control a flow rate of liquid refrigerant flowing out from the liquid phase portion into the internal piping via the valve hole.

The above and other objects, features and advantages of the present invention will become apparent from the following description when taken in conjunction with the accompanying drawings which illustrate preferred embodiments of the present invention by way of example.

### BRIEF DESCRIPTION OF THE DRAWINGS

FIG. 1 is a diagram showing a system configuration of a refrigeration cycle according to an embodiment of the present invention.

FIG. 2 is a cross-sectional view showing the construction of an accumulator.

FIG. 3 is a Mollier chart which is useful in explaining the operation of the refrigeration cycle.

FIG. 4 is a diagram showing a system configuration of a conventional supercritical refrigeration cycle.

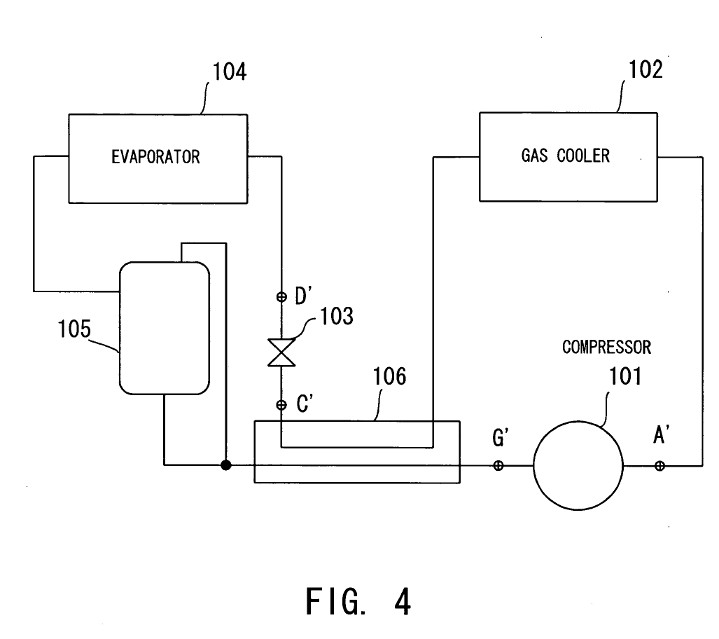

### DESCRIPTION OF THE PREFERRED EMBODIMENTS

Hereinafter, an embodiment of the present invention will be described in detail with reference to the drawings.

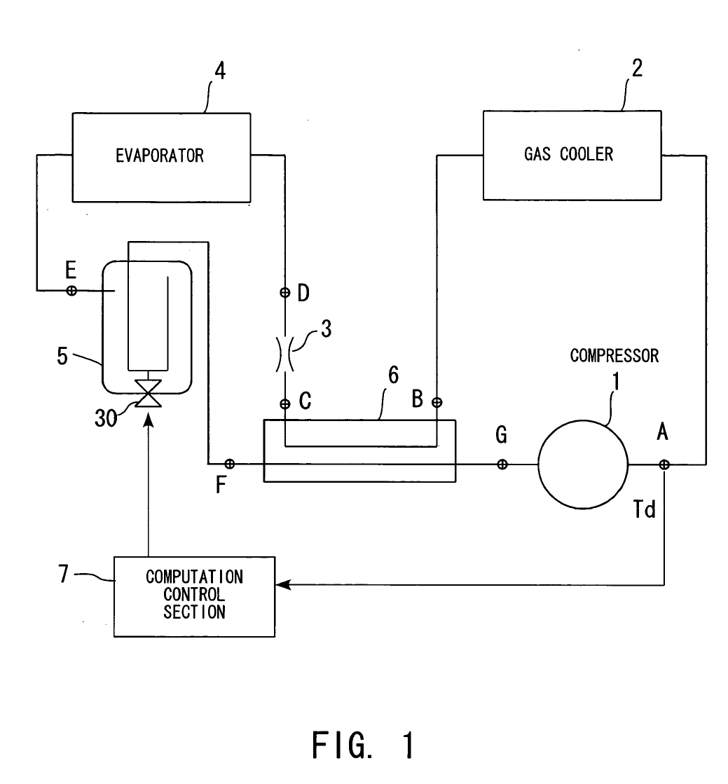

The present embodiment, in which a refrigeration cycle of the present invention is applied to an automotive air conditioner, is configured as a supercritical refrigeration cycle using carbon dioxide as refrigerant. FIG. 1 is a diagram showing a system configuration of the refrigeration cycle according to the embodiment.

The refrigeration cycle according to the present embodiment is driven for rotation by en engine for an automotive vehicle, and comprises a compressor 1 for compressing refrigerant to a supercritical region, a gas cooler 2 (external heat exchanger) for cooling refrigerant discharged from the compressor 1, an expansion device 3 for decompressing refrigerant delivered from the gas cooler 2, an evaporator 4 for evaporating refrigerant decompressed by passing through the expansion device 3, an accumulator 5 for storing refrigerant delivered from the evaporator 4 while causing gas-liquid separation of the refrigerant, an internal heat exchanger 6 for performing heat exchange between refrigerant delivered from the accumulator 5 to the compressor 1 and refrigerant delivered from the gas cooler 2 to the expansion device 3, and a computation control section 7 (control means, liquid refrigerant outflow control means) for controlling a control valve (refrigerant sending means), referred to hereinafter, of the accumulator 5 according to an operating condition of the refrigeration cycle.

Oil for lubrication (lubricating oil) circulates through the compressor 1, and part of the lubricating oil is delivered together with high-pressure refrigerant when the refrigerant is discharged, to circulate though the refrigeration cycle.

The expansion device 3 is configured as an orifice (restriction passage) having a fixed passage cross-section.

The accumulator 5 is provided with a mechanism for returning the lubricating oil mixed in a liquid phase portion thereof, to the compressor 1.

In the internal heat exchanger 6, refrigerant flowing from the gas cooler 2 to the evaporator 4 is cooled by refrigerant flowing from the accumulator 5 to the compressor 1, and at the same time the refrigerant flowing from the accumulator 5 to the compressor 1 is heated by the refrigerant flowing from the gas cooler 2 to the evaporator 4. This makes it possible to enhance the refrigerating power of the refrigeration cycle.

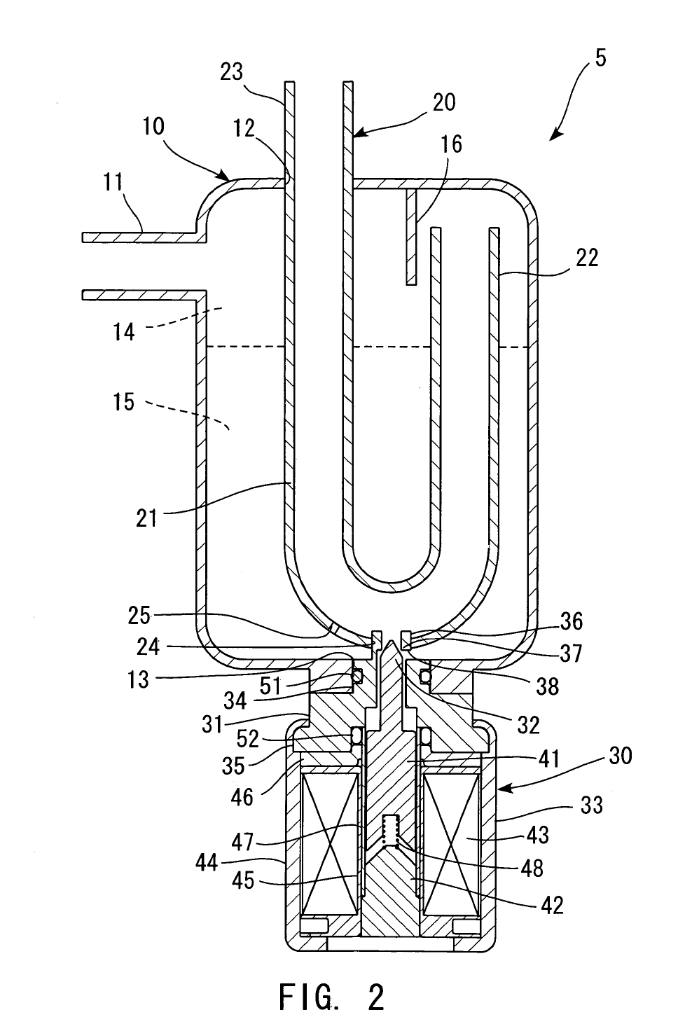

Next, a detailed description will be given of the construction of the accumulator 5. FIG. 2 is a cross-sectional view showing the construction of the accumulator 5.

As shown in FIG. 2, the accumulator 5 comprises a tank 10 for storing refrigerant sent from the evaporator 4, a U-shaped pipe 20 (internal piping) for guiding gaseous refrigerant formed by gas-liquid separation of the refrigerant stored in the tank 10, to the compressor 1, and a control valve 30 operable when part of liquid refrigerant in the tank 10 is allowed to flow into the U-shaped pipe 20, to control the flow rate of the liquid refrigerant.

The tank 10 has an upper portion thereof formed with an inlet port 11 extending outward to be connected to piping, not shown, communicating with the evaporator 4, and an upper end face thereof formed with a hole 12 for allowing one end of the U-shaped pipe 20 to extend therethrough. Further, the tank 10 has an opening 13 formed in the center of a lower end thereof, and the control valve 30 is fixed to the opening 13 by fitting a body 31 thereof in the opening 13. The tank 10 has a gaseous phase portion 14 for storing gaseous refrigerant and the liquid phase portion 15 for storing liquid refrigerant, formed at respective upper and lower locations inside the tank 10. Furthermore, the tank 10 is formed with an obstruction plate 16 extending downward from an upper end wall thereof by a predetermined length.

The U-shaped pipe 20 has a body 21 curved to form a U shape, and the body 21 has one end 22 opening in the gaseous phase portion 14 at an upper location in the tank 10, and the other end 23 extending through the hole 12 in the top of the tank 10, for communication with the internal heat exchanger 6. The open end of the one end 22 is enclosed by the obstruction plate 16 so as to prevent refrigerant flowing from the inlet port 11 into the tank 10 in a gas-liquid mixture state from being directly drawn into the U-shaped pipe 20. Further, a communication hole 24 communicating with the liquid phase portion 15 in the tank 10 is formed in a central portion of a lower end of the body 21. Furthermore, in the vicinity of the communication hole 24 of the body 21, there is formed a refrigerant passage 25 communicating between the liquid phase portion 15 in the tank 10 and the inside of the U-shaped pipe 20 for delivering liquid refrigerant at a lowest flow rate enabling prevention of seizure of the compressor 1 even when the communication hole 24 is closed. It should be noted that the lowest flow rate is set to an appropriate value in advance based on the flow rate characteristics of refrigerant in the refrigeration cycle.

The control valve 30 comprises a body 31 integrally formed with the tank 10, a valve element 32 disposed inside the body 31, and a solenoid 33 for performing actuation control of the valve element 32.

The body 31 has a stepped hollow cylindrical shape having a reduced-diameter portion 34 at an upper end thereof, and a flange portion 35 radially outwardly extending at a lower end thereof. The reduced-diameter portion 34 is fixed in the opening 13 of the tank 10 by being press-fitted therein. Interposed between the reduced-diameter portion 34 and the opening 13 is an O ring 51 for sealing therebetween to prevent liquid refrigerant in the tank 10 from flowing out to the outside. Further, a hollow cylindrical refrigerant passage-forming portion 36 is provided coaxially with the valve element 32 such that it protrudes from an end face of the reduced-diameter portion 34. The refrigerant passage-forming portion 36 is fitted in the communication hole 24 of the U-shaped pipe 20, and integrally formed with a valve seat 37 for having the valve element 32 seated thereon. A valve hole is formed by a portion defining the valve seat 37 and communicating with the inside of the body 21 of the U-shaped pipe 20. Further, the refrigerant passage-forming portion 36 has a side portion thereof formed with a communication hole 38 for causing an inside thereof to communicate with the liquid phase portion 15 in the tank 10 such that when a valve portion formed by the valve element 32 and the valve seat 37 is open, part of liquid refrigerant in the liquid phase portion 15 is allowed to flow out into the body 21 of the U-shaped pipe 20 via the communication hole 38.

The solenoid 33 includes a plunger 41 integrally formed with the valve element 32, a core 42 disposed below the plunger 41 coaxially therewith, a solenoid coil 43 for generating a magnetic circuit including the plunger 41 and the core 42 by electric current externally supplied thereto, and a hollow cylindrical yoke 44 disposed in a manner covering the solenoid coil 43 to form a casing of the solenoid 33.

The yoke 44 has one end thereof fixed to the flange portion 35 of the body 31 by caluking the one end such that the one end covers the flange portion 35. The solenoid coil 43 is wound around a hollow cylindrical bobbin 45, and the core 42 is disposed in a lower half of the bobbin 45. The core 42 has a lower end thereof press-fitted in a lower end of the bobbin 45.

Disposed between the bobbin 45 and the body 31 is a metal plate 46 in the form of a disk, which has a circular hole in the center thereof, and inside the bobbin 45 and the plate 46 is mounted a sleeve 47 made of a non-magnetic material, which extends from a lower end of the body 31 to an upper half of the core 42. Interposed between the sleeve 47 and the body 31 is an O ring 52 for sealing therebetween to prevent liquid refrigerant in the tank 10 from flowing out to the outside.

The internal component parts of the solenoid 33 are fixed in a state accommodated in the yoke 44, by caulking of the other end of the yoke 44 radially inward.

The plunger 41 includes a cylindrical body having an outer diameter slightly smaller than the inner diameter of the sleeve 47, with a circular accommodating groove recessed in the center of a lower end thereof to a predetermined depth. The accommodating groove accommodates a compression coil spring 48 such that the compression coil spring 48 is interposed between the plunger 41 and the core 42 for urging the plunger 41 in a direction away from the core 42. The long valve element 32 extends upward from an upper end face of the plunger 41. The plunger 41 has a lower end formed to have a tapered shape sloped outward as it extends downward.

The core 42 includes a cylindrical body whose upper end has a complementary shape to the tapered portion of the plunger 41, with a foremost end face thereof supporting an end of the compression coil spring 48.

In the arrangement described above, the magnetic circuit of the solenoid 33 surrounding the solenoid coil 43 is formed by the plunger 41, the core 42, the yoke 44, the plate 46, and so forth, and the energization of the solenoid coil 43 is controlled by the aforementioned computation control section 7.

More specifically, when the solenoid coil 43 is not energized and hence the solenoid 33 is not driven, the valve element 32 is seated on the valve seat 37 by the urging force of the compression coil spring 48, whereby liquid refrigerant within the liquid phase portion 15 is allowed to flow out into the inside of the U-shaped pipe 20 via the refrigerant passage 25 at the lowest flow rate set in advance, mixed with gaseous refrigerant, and delivered to the outside of the accumulator 5. The lowest flow rate here is set based on the amount of the lubricating oil required by the compressor 1. As a result, when the compressor 1 draws gaseous refrigerant separated from liquid refrigerant by the accumulator 5, the lubricating oil is supplied to the compressor 1, whereby seizure of the compressor 1 caused by depletion of the lubricating oil can be prevented.

On the other hand, when the solenoid coil 43 is energized and hence the solenoid 33 is driven, the plunger 41 is attracted toward the core 42, and the valve element 32 is lifted from the valve seat 37 to open the valve portion. The valve lift of the valve portion is substantially proportional to the value of electric current supplied to the solenoid coil 43. Therefore, the liquid refrigerant within the liquid phase portion 15 is allowed to flow out into the inside of the U-shaped pipe 20 not only via the refrigerant passage 25, as described above, but also via the valve hole of the valve portion at the flow rate proportional to the value of the electric current. The liquid refrigerant flowing out via the refrigerant passage 25 and the valve hole of the valve portion is mixed with gaseous refrigerant flowing through the U-shaped pipe 20, and delivered to the outside of the accumulator 5.

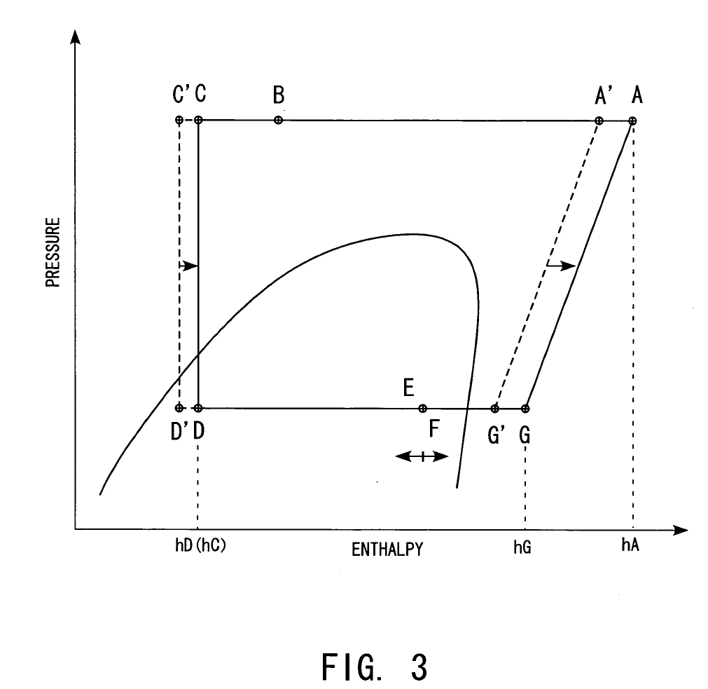

Next, a description will be given of the operation of the refrigeration cycle configured as above. FIG. 3 shows a Mollier chart which is useful in explaining the operation of the refrigeration cycle. In FIG. 3, the horizontal axis represents enthalpy, and the vertical axis represents the pressure of refrigerant. Point A to Point G in FIG. 3 correspond to the locations of Point A to Point G in FIG. 1. Point A represents a state of refrigerant, which circulates through the refrigeration cycle, at a discharge port of the compressor 1, Point B a state of the refrigerant at an outlet of the gas cooler 2, Point C a state of the refrigerant at an inlet of the expansion device 3, Point D a state of the refrigerant at an outlet of the expansion device 3, Point E a state of the refrigerant at an inlet of the accumulator 5, Point F a state of the refrigerant at an outlet of the accumulator 5, and Point G a state of the refrigerant at a suction port of the compressor 1. Further, in FIG. 3, the operation of the refrigeration cycle according to the present embodiment is indicated by solid lines, and an example of the operation of the conventional refrigeration cycle is indicated by dotted lines as a comparative example.

As shown in FIG. 3, the refrigeration cycle operates along lines indicated by A-B-C-D-E-F-G in the Mollier chart. Refrigerant flowing through the refrigeration cycle has its pressure increased by the compressor 1, and is discharged as high-pressure, high-temperature refrigerant (G→A). The refrigerant discharged at this time in a gaseous phase state is cooled by the gas cooler 2 (A→B), and further cooled by heat exchange by the internal heat exchanger 6 (B→C). The refrigerant cooled at this time is adiabatically expanded by passage through the expansion device 3, to be changed into low-pressure, low-temperature refrigerant in a two-phase gas-liquid state (C→D), and evaporated by passage through the evaporator 4 (D→E). When the refrigerant is evaporated, it cools air in the compartment by depriving the air of latent heat of vaporization. It should be noted that in the case where carbon dioxide is used as refrigerant, when the refrigerant is cooled by the gas cooler 2, pressure thereof does not cross the saturated vapor line, so that the refrigerant is not condensed and remains in a gaseous phase at the outlet of the gas cooler 2, and when decompressed by the expansion device 3, the refrigerant is changed in phase from the gaseous phase state to the two-phase gas-liquid state when the pressure of the refrigerant becomes lower than the saturated vapor line.

Then, the accumulator 5 carries out gas-liquid separation of the refrigerant having passed through the evaporator 4 in the two-phase gas-liquid state, and delivers mainly the resulting gaseous refrigerant. However, to return the lubricating oil contained in the liquid refrigerant to the compressor 1, part of the liquid refrigerant is mixed with the gaseous refrigerant, and delivered to the compressor side (E→F). For this reason, refrigerant in the two-phase gas-liquid state, with a predetermined degree of dryness, is delivered from the accumulator 5. The refrigerant is caused to pass through the internal heat exchanger 6 to be heated by heat exchange, and controlled such that it is heated to a predetermined degree of superheat above the saturated vapor line (F→G). Then, the refrigerant whose degree of superheat is controlled enters the compressor 1, where the refrigerant has its pressure increased again to be changed from the state of Point G into the state of Point A.

Now, a method of controlling the refrigeration cycle according to the present embodiment will be described with reference to FIG. 3.

In the refrigeration cycle, as described above, the degree of dryness of the accumulator 5 can be adjusted by controlling the valve lift of the valve portion by the control valve 30. More specifically, the position of Point F shown in the FIG. 3 Mollier chart can be moved between D and G by control of the valve lift, and by making use of this control, the coefficient of performance of the refrigeration cycle is improved.

It should be noted that the coefficient of performance represents an efficiency indicative of an amount of work required by the compressor 1 in absorbing heat by the evaporator 4. When the coefficient of performance is represented by COP, it is expressed by the following equation using an enthalpy difference (hA−hG) of the compressor 1 and an enthalpy difference (hG−hD) of the evaporator 4:
COP=(hG−hD)/(hA−hG) (1)

When the numerator of the above equation becomes larger, the coefficient of performance is improved. When the coefficient of performance is improved, the required cooling power can be obtained by a smaller power, which reduces load on the engine for driving the automotive air conditioner, whereby an energy-saving operation of the engine can be expected.

In the present embodiment, the valve lift of the control valve 30 is controlled by the computation control section 7 such that the position of Point F is adjusted to a side where the enthalpy is increased (right-hand side as viewed in FIG. 3), whereby the temperature of refrigerant discharged from the compressor 1 is made close to an upper limit temperature (150° C. in the present embodiment) of the range of temperatures within which the lubricating oil is not degraded. This adjustment is performed by detecting a temperature Td at the discharge port of the compressor 1, shown in FIG. 1. More specifically, Point F is moved rightward to increase the degree of dryness of refrigerant having passed through the accumulator 5, whereby the degree of superheat at the suction port of the compressor 1 is increased to move Point G relatively rightward (from Point G′ to Point G). At this time, in the compressor 1, the pressure of the refrigerant is increased substantially along an isentrope, and hence Point A as well is moved relatively rightward (to Point A rightward of Pont A′), but there is almost no change in the enthalpy difference (hA−hG) of the compressor 1.

On the other hand, since there is no external energy input or output in the heat exchange by the internal heat exchanger 6, the enthalpy difference between F and G and the enthalpy difference between B and C become equal to each other, but a rise in the temperature between C′ and C is made smaller than a rise in the temperature between A′ and A, and hence the amount of rightward movement of Point C is made smaller than the amount of rightward movement of Point A. Therefore, the amount of rightward movement of Point D is made smaller than the amount of rightward movement of Point G, whereby the enthalpy difference (hG−hD) in the evaporator 4 is made relatively larger.

As a result, according to the above equation (1), the refrigeration cycle of the present embodiment is further improved in the coefficient of performance than the refrigeration cycle in the comparative example, operating along lines indicated by A′-C′-D′-G′ in the Mollier chart. Further, since the improvement in the coefficient of performance is realized by control of the degree of dryness of refrigerant delivered by the accumulator 5, that is, by control of Point F in FIG. 3, there is no need to lower the pressure (Point A) of refrigerant discharged from the compressor 1, and hence the improvement in the coefficient of performance can be realized without lowering the cooling power of the refrigeration cycle.

As described hereinabove, according to the refrigeration cycle of the present embodiment, it is possible to adjust the flow rate of liquid refrigerant to be mixed with gaseous refrigerant in the U-shaped pipe 20, by the control valve 30 integrally formed with the accumulator 5, and enhance the degree of dryness of refrigerant delivered from the accumulator 5 while securing the required amount of lubricating oil. As a result, it is possible to increase the degree of superheat of refrigerant introduced into the compressor 1, thereby making it possible to improve the coefficient of performance of the refrigeration cycle. In doing this, there is no need to lower the pressure of refrigerant discharged from the compressor 1, and hence the improvement in the coefficient of performance can be realized without lowering the cooling power of the refrigeration cycle.

Although the preferred embodiment of the present invention has been described heretofore, the present invention is by no means limited to the specific embodiment, but various modifications and alterations can be made thereto without departing from the spirit and scope of the present invention.

For example, although in the above-described embodiment, the control valve 30 is configured as a solenoid valve driven by the solenoid 33, and the valve lift of the valve portion thereof is variably controlled in proportion to the value of electric current supplied to the solenoid coil 43, by way of example, this is not limitative, but the energization of the solenoid 33 may be turned on or off to open or close the valve portion such that the flow rate of refrigerant flowing out into the U-shaped pipe 20 is controlled. Further, the control valve may be configured such that the valve portion is caused to be opened and closed e.g. by a stepping motor, or it may be configured as a so-called mechanical type control valve in which the valve element is actuated by an internal mechanical construction including springs and the pressure of refrigerant.

Further, although in the above-described embodiment, the expansion device 3 is configured as an orifice having a fixed passage cross-section, by way of example, this is not limitative, but the expansion device 3 may be configured as an expansion valve having a valve mechanism disposed therein. In this case, it is also possible to configure the control valve 30 as a mechanical type control valve at a reduced cost and employ a method of performing fine adjustment of a differential pressure across the valve portion by the expansion valve. However, while the differential pressure of refrigerant across the valve portion to be handled by the expansion device 3 is generally in a range of 30 to 100 kgf/cm² under the present circumstances, the differential pressure of refrigerant to be handled by the control valve 30 is approximately 1/1000 kgf/cm² even when the differential pressure is calculated assuming that the water column is approximately 10 cm in height. This value is considerably small. Consequently, it is easier to electrically control the control valve 30 itself than to control the valve lift of the control valve 30 by electrically controlling the expansion device 3, and moreover electric control of the control valve 30 itself can be realized by a simple construction. Therefore, by configuring the expansion device 3 as an inexpensive orifice, and the control valve 30 as a solenoid valve as in the above embodiment, it is possible to realize the refrigeration cycle of the present invention at a very low cost.

Further, although in the above-described embodiments, the refrigeration cycle of the present invention is configured as a supercritical refrigeration cycle which uses carbon dioxide as refrigerant, and makes the pressure of the refrigerant before being decompressed by the expansion device 3 not lower than the critical pressure of the refrigerant, by way of example, this is not limitative, but the refrigeration cycle may be configured as a supercritical refrigeration cycle using refrigerant other than carbon dioxide. Further, it is also possible to configure the refrigeration cycle not as a supercritical refrigeration cycle but as a refrigeration cycle which uses a chlorofluorocarbon or the like as refrigerant, and in which the pressure of the refrigerant before being decompressed by the expansion device 3 is lower than the critical pressure of the refrigerant. In this case, however, since there hardly occurs a change in temperature between Point A to Point C shown in FIG. 3, it is considered that the degree of improvement in the coefficient of performance attained by controlling the valve lift of the accumulator 5 is smaller than attained by the above described embodiment.

According to the refrigeration cycle of the present invention, it is possible to adjust the flow rate of liquid refrigerant to be mixed with gaseous refrigerant in the internal piping by the control valve integrally formed with the accumulator, and enhance the degree of dryness of refrigerant delivered from the accumulator while securing the required amount of the lubricating oil. As a result, it is possible to increase the degree of superheat of refrigerant introduced into the compressor, thereby making it possible to improve the coefficient of performance of the refrigeration cycle. In doing this, there is no need to lower the pressure of refrigerant discharged from the compressor, and hence the improvement in the coefficient of performance can be realized without lowering the cooling power of the refrigeration cycle.

The foregoing is considered as illustrative only of the principles of the present invention. Further, since numerous modifications and changes will readily occur to those skilled in the art, it is not desired to limit the invention to the exact construction and applications shown and described, and accordingly, all suitable modifications and equivalents may be regarded as falling within the scope of the invention in the appended claims and their equivalents.

1. A refrigeration cycle comprising:
a compressor for compressing refrigerant containing lubricating oil;
an external heat exchanger for cooling the refrigerant discharged from the compressor;
an expansion device for decompressing the refrigerant sent from the external heat exchanger;
an evaporator for evaporating the refrigerant decompressed by the expansion device;
an accumulator for storing the refrigerant sent from the evaporator while causing gas-liquid separation thereof; and
an internal heat exchanger for performing heat exchange between the refrigerant sent from the accumulator to the compressor and the refrigerant sent from the external heat exchanger to the expansion device,
wherein the accumulator comprises:
a tank for storing the refrigerant sent from the evaporator;
an internal piping having a body accommodated in the tank, the body having one end which opens into a gaseous phase portion within the tank and the other end which extends through the tank so as to be connected to the internal heat exchanger side, and further the body being formed with a valve hole having a predetermined size, for communication with a liquid phase portion within the tank; and
a control valve having a main body formed integrally with the tank, a valve element disposed within the main body such that the valve element can be moved to and away from the valve hole and forming a valve portion for opening and closing the valve hole, and control means for causing the valve element to be driven in a direction of opening or closing the valve portion to thereby control a flow rate of liquid refrigerant flowing out from the liquid phase portion into the internal piping via the valve hole.

2. The refrigeration cycle according to claim 1, wherein pressure of the refrigerant before being decompressed by the expansion device is not lower than a critical pressure of the refrigerant.

3. The refrigeration cycle according to claim 2, wherein the control means causes the valve element to be driven such that the liquid refrigerant can be sent into the internal piping at a flow rate set in advance so as to make temperature of the refrigerant discharged from the compressor close to an upper limit of a temperature range within which the lubricating oil is not degraded.

4. The refrigeration cycle according to claim 2, wherein the expansion device is formed by a restriction passage having a fixed passage cross-section.

5. The refrigeration cycle according to claim 2, comprising a solenoid for driving the valve element in a direction of opening or closing the valve portion, and
wherein the control means controls the flow rate of the liquid refrigerant flowing out into the internal piping by turning on or off energization of the solenoid to cause the valve portion to be opened or closed thereby.

6. The refrigeration cycle according to claim 2, comprising a solenoid for driving the valve element in the direction of opening or closing the valve portion, and
wherein the control means causes electric current to be supplied to the solenoid to thereby cause the valve portion to be opened to a valve lift proportional to a value of the electric current.

7. The refrigeration cycle according to claim 2, wherein the internal piping is formed with a refrigerant passage for causing the liquid refrigerant to be supplied therethrough at a minimum flow rate set in advance such that seizure of the compressor can be prevented even when the valve portion is closed.

8. A refrigeration cycle comprising:
a compressor for compressing refrigerant containing lubricating oil;
an external heat exchanger for cooling the refrigerant discharged from the compressor;
an expansion device for decompressing the refrigerant sent from the external heat exchanger;
an evaporator for evaporating the refrigerant decompressed by the expansion device;
an accumulator for storing the refrigerant sent from the evaporator while causing gas-liquid separation thereof;
an internal heat exchanger for performing heat exchange between the refrigerant sent from the accumulator to the compressor and the refrigerant sent from the external heat exchanger to the expansion device;
refrigerant sending means for causing part of liquid refrigerant in the accumulator to flow out to be mixed with gaseous refrigerant, to thereby send the part of the liquid refrigerant to the internal heat exchanger side; and
liquid refrigerant outflow control means for controlling an outflow rate of the liquid refrigerant to be mixed with the gaseous refrigerant, to thereby cause the liquid refrigerant to flow out at a flow rate set in advance so as to make temperature of the refrigerant discharged from the compressor close to an upper limit of a temperature range within which the lubricating oil is not degraded.

9. The refrigeration cycle according to claim 8, wherein pressure of the refrigerant before being decompressed by the expansion device is not lower than a critical pressure of the refrigerant.

10. An accumulator applied to a refrigeration cycle including a compressor for compressing refrigerant containing lubricating oil, an external heat exchanger for cooling the refrigerant discharged from the compressor, an expansion device for decompressing the refrigerant sent from the external heat exchanger, an evaporator for evaporating the refrigerant decompressed by the expansion device, the accumulator for storing the refrigerant sent from the evaporator while causing gas-liquid separation thereof, and an internal heat exchanger for performing heat exchange between the refrigerant sent from the accumulator to the compressor and the refrigerant sent from the external heat exchanger to the expansion device,
wherein the accumulator comprises:
a tank for storing the refrigerant sent from the evaporator;
an internal piping having a body accommodated in the tank, the body having one end which opens into a gaseous phase portion within the tank and the other end which extends through the tank so as to be connected to the internal heat exchanger side, and further, the body being formed with a valve hole having a predetermined size, for communication with a liquid phase portion within the tank; and
a control valve having a main body formed integrally with the tank, a valve element disposed within the main body such that the valve element can be moved to and away from the valve hole and forming a valve portion for opening and closing the valve hole, and drive means for causing the valve element to be driven in a direction of opening or closing the valve portion to thereby adjust an outflow rate of liquid refrigerant from the liquid phase portion within the tank into the internal piping.

11. The accumulator according to claim 10, wherein the drive means drives the valve element such that the liquid refrigerant can be sent into the internal piping at a flow rate set in advance so as to make temperature of high-pressure refrigerant discharged from the compressor close to an upper limit of a temperature range within which the lubricating oil is not degraded.

12. The accumulator according to claim 11, wherein the drive means comprises a solenoid for driving the valve element in the direction of opening or closing the valve portion, and adjusts a valve lift of the valve portion according to an amount of electric current supplied to the solenoid.

13. The accumulator according to claim 11, wherein the internal piping is formed with a refrigerant passage for causing the liquid refrigerant to be supplied therethrough at a minimum flow rate set in advance such that seizure of the compressor can be prevented even when the valve portion is closed.
